(19) United States
(12) Patent Application Publication
(10) Pub. No.: US 2007/0182636 A1
(43) Pub. Date: Aug. 9, 2007

(54) Dual band trace antenna for WLAN frequencies in a mobile phone

(75) Inventor: Nicklas Carlson, Marieita, GA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/348,025

(22) Filed: Feb. 6, 2006

(51) Int. Cl. H01Q 1/38; H01Q 1/24

(52) U.S. Cl. 343/700 MS; 343/702

(57) ABSTRACT

An antenna for use in mobile electronic devices at more than one frequency. A circuit board contains a first antenna element at a first layer and a second antenna element at a second layer. The antenna elements have a common feed connection and ground connection. The antenna elements are arranged substantially parallel to each other on their respective layers in the circuit board. The first antenna element has a length that differs from that of the second antenna element to provide each with a different resonant frequency.

### FIELD OF THE INVENTION

The present invention relates an internal dual band antenna for a hand portable radio device. Preferred embodiments of the invention are particularly suited for operation at frequencies allocated for Wireless Local Area Network (WLAN) communication.

### BACKGROUND INFORMATION

There is a desire for hand portable devices with the ability to communicate, such as mobile radiotelephones, to become increasingly smaller and more compact. Due to such requirements, there is a need to provide compact solutions within the hand portable device. For example, integrated circuits (IC's) are becoming more densely packed as they include a plurality of circuits and components.

Additionally, mobile telephones may operate via a plurality of different wireless protocols, for example the global system for mobile communication (GSM), wireless Local Area Network (WLAN), and Global Positioning System (GPS). Each protocol includes associated circuitry contained within the radio handset, and each protocol is able to receive and transmit electromagnetic energy by way of an antenna.

Wireless Local Area Network is a type of local-area network that uses high-frequency radio waves rather than wires to communicate between nodes. WLANs enable mobile users to connect to a local-area network (LAN) through a wireless (radio) connection. The IEEE 802.11 standard specifies the technologies for wireless LANs. At present, there are a number of variants of WLAN which fall under the 802.11 standards. For example, the 802.11b standard outlines use at approximately 2.4 GHz and with a data rate of 11 Mbits/s, and the 802.11a standard outlines use at approximately 5.8 GHz and with a data rate of up to 54 Mbits/s. Dependent upon the territory, these allocations/standards may differ slightly.

In older style radio telephones, antennas were traditionally mounted on the external cover of a radio telephone, for example a whip or stub antenna. More recently, radiotelephones have utilized internal antennas so as to provide a more aesthetically pleasing product that may be easily stored in a user's pocket. However, as the number of wireless protocols that a radiotelephone must support increases, so must the number of antennas.

An internal antenna such as a planar inverted F antenna (PIFA) can resonate at more than one frequency, the resonant frequencies, for example, corresponding to an electrical length of one quarter wavelength and at three quarters of a wavelength. While the aforementioned antenna provides a space efficient means of providing an antenna resonant at two frequency bands, it is appreciated by those skilled in the art that the ratio between the two frequency bands will be of the order of 3:1. This type of antenna is not therefore suited to covering two resonant frequencies with a ratio of approximately 2:1.

Also, each resonant frequency of the PIFA has an associated impedance which will be different, possibly of the order of 4:1. It would be preferable that at each resonant frequency the match presented by the antenna to the associated circuitry was 50 ohms.

Furthermore, in order to operate over as wide a frequency bandwidth as possible, PIFA's need to be located at a certain distance above a ground plane; generally the greater the separation distance between the PIFA and the ground plane, the larger the antenna bandwidth. Therefore, a disadvantage of using PIFA's inside a radio telephone is that they are generally not constructed as a part of the printed circuit board to which electronic circuitry may be mounted as the separation distance between the radiation element and the ground plane would be very small. Typically, these antennas are mounted to a radiotelephone housing or to an internal mount within the handset so as to provide a separation distance and therefore an antenna with sufficient operational bandwidth.

There is therefore a requirement to provide a space efficient antenna structure that can operate in a plurality of wireless protocols yet provide easily alterable matching characteristics.

It is therefore an aim of embodiments of this invention to provide an antenna structure that is space efficient, can operate at a plurality of frequencies and can be easily matched to coupled radio circuitry.

### SUMMARY OF THE INVENTION

According to a first aspect of the invention, there is a dual band antenna comprising a circuit board having a plurality of layers, a first antenna element formed on a first layer and having a ground connection, a second antenna element formed on a second layer and having a ground connection, and a common feed circuit connected to the first and second antenna element, wherein the first and second elements are positioned adjacent to an edge of the circuit board.

According to a second aspect of the invention, there is a portable radio device comprising a circuit board for mounting components and having a plurality of layers, a first antenna element formed on a first layer of the circuit board and having a ground connection, a second antenna element formed on a second layer of the circuit board and having a ground connection, and a common feed circuit connected to the first and second antenna element, wherein the first and second elements are positioned adjacent to an edge of the circuit board.

These and other objects, advantages, and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view illustrating one of the antenna elements constructed as part of a circuit board according to the principles of the present invention;

FIG. 2 is a side view showing an embodiment of the present invention illustrating the overlap between the first and second element;

FIG. 3 illustrates a perspective view of a circuit board having the longer of the two traces and the feed connection;

FIG. 4 is a illustration of the opposite side of the circuit board shown in FIG. 3, showing the shorter of the two traces;

FIG. 5 is a perspective view illustrating both traces of the antenna of one embodiment of present invention and including a signal feed connection and ground connection;

FIGS. 6(a) and (b) illustrates one of the antenna elements constructed as part of a circuit board according to the principles of the present invention;

FIG. 7 is a perspective view of a mobile telephone that can be used in the implementation of the present invention;

FIG. 8 is a schematic representation of the telephone circuitry of the mobile telephone of FIG. 7;

FIG. 9 is a perspective view illustrating three traces of the antenna of one embodiment of the present invention, two fed via a signal feed connection, and a third parasitic trace;

FIG. 10 is a perspective view illustrating three traces of the antenna of one embodiment of the present invention, two fed via a signal feed connection, and a third parasitic trace, with the parasitic trace positioned on the same face of a printed circuit board as the first trace;

FIG. 11 is a perspective view illustrating three traces of the antenna of one embodiment of the present invention, two fed via a signal feed connection, and a third parasitic trace;

FIG. 12 is a perspective view illustrating three traces of the antenna of one embodiment of the present invention, two fed via a signal feed connection, and a third parasitic trace which is positioned on a different face of the printed circuit board than the first and second traces; and

FIG. 13 illustrates a integrated circuit including a first antenna element and a second antenna element in accordance with the principles of the present invention.

### DETAILED DESCRIPTION OF THE PREFERRED EMBODIMENTS

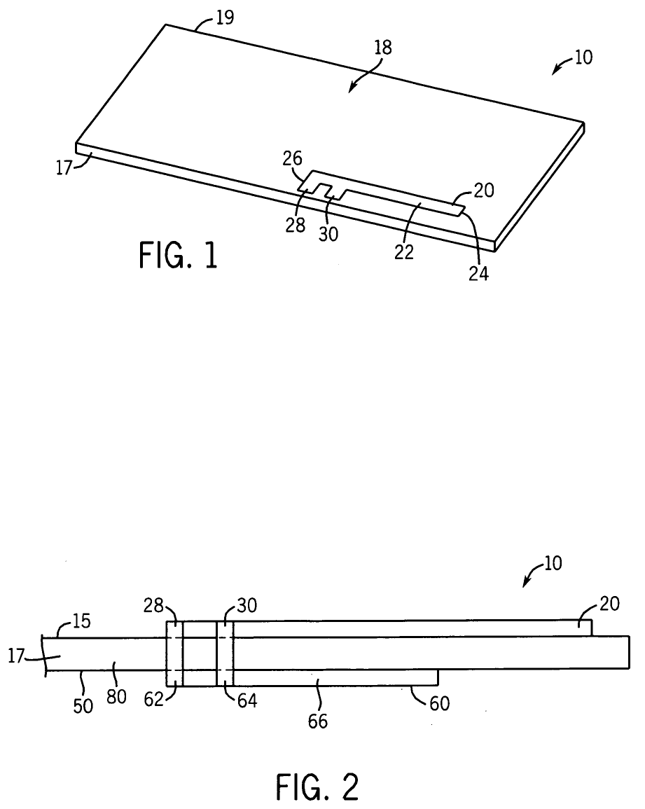

In one embodiment the antenna of the present invention are mounted on a printed circuit board (PCB) 10. A PCB 10 is illustrated in FIG. 1. The PCB is rectangular and comprises a front face 15 and two parallel edges 17, 19. The PCB 10 may comprise a plurality of solder pads for connecting electronic components during manufacture of a portable electronic device. For clarity, the solder pads and any associated circuitry are not shown, but nonetheless would be understood by those skilled in the art. The PCB is dimensioned so as to be assembled within a portable electronic device, hence the geometry of the PCB is not essential to the present invention. In one embodiment, the PCB may be a board without components placed on it. In an exemplary embodiment, the PCB is a substrate material having a connection to another board or element. Therefore, one skilled in the art will appreciate that the antenna according to the present invention may be mounted or constructed to various PCB's without departing from the scope of the invention.

According to a first embodiment an antenna 20 is constructed as part of the etching process on the front face 15 of the PCB 10. The antenna 20 is planar and realized using strip line. An advantage of this embodiment is that the antenna 20 is produced at reduced cost when compared to the cost of manufacturing the PCB 10. The antenna is located towards one of the parallel edges, i.e. towards and edge of the PCB 10.

The antenna 20 is commonly referred to as an inverted F antenna (IFA); it comprises a radiation element or trace 22 running parallel with the edge 17. The radiation element 22 has an open circuit end 24 and a short circuit end 26. Defining the short circuit end 26 is a ground point 28. The ground point 28 creates a DC path to the ground of the portable electronic device; the electrical length of the radiation element is defined by the distance between the ground point 28 and the open circuit end 24. Adjacent to the ground point 28 is a feed point 30 that is coupled to radio circuitry contained within the portable electronic device.

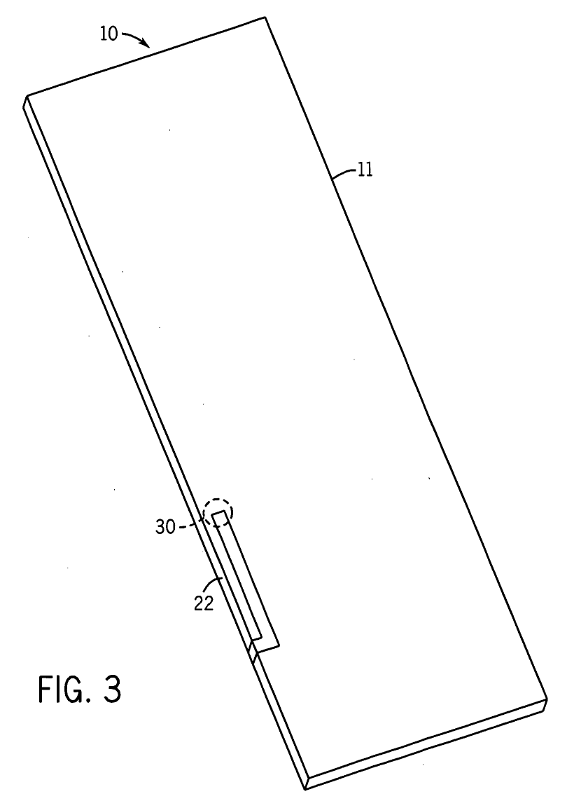

FIG. 2 illustrates a side view of the PCB 10 looking towards the edge 17. The PCB 10 further comprises a rear face 50 which is parallel to the front face 15 and is separated by a dielectric material 80. Located on the rear face 50 of the PCB 10 there is a second antenna 60. In one embodiment, the second antenna 60 is of similar construction to the antenna 20. The second antenna 60 has a radiation element 66,a ground point 62 and a feed point 64. As with the antenna 20 the second antenna 60 may be an IFA. In accordance with the principles of the present invention, a plurality of antenna may be provided.

In one embodiment the antenna elements 20, 60 are adjacent to the edge 17 of the PCB 10. In an exemplary embodiment at least one of the antenna elements 20, 60 are positioned adjoining the edge 17. In another exemplary embodiment, at least one of the antenna elements 20, 60 are spaced some distance from and not in contact with the edge 17. In an exemplary embodiment, at least one of the antenna elements 20, 60 are positioned with additional material, such as circuit board material, between the antenna elements 20, 60 and the edge 17.

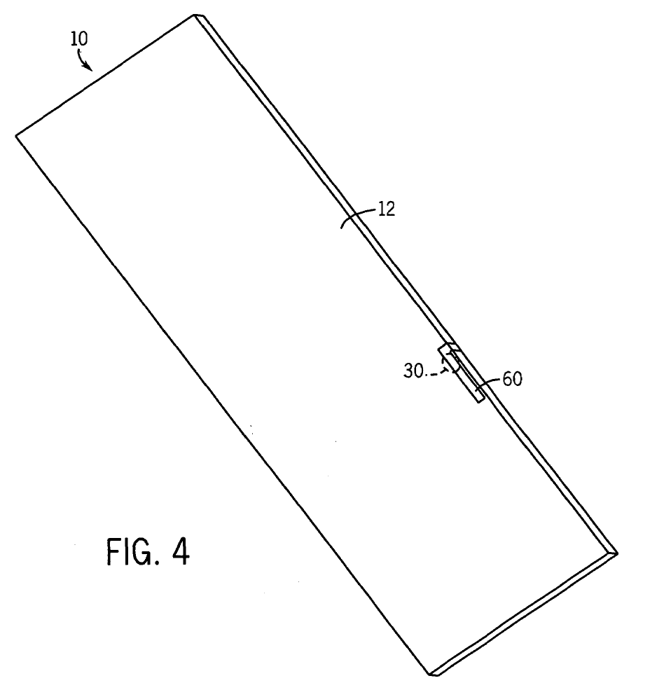

FIGS. 3 and 4 illustrate the position of the antenna 20 components of one embodiment of the present invention. FIG. 4 illustrates a shorter (relative to the first radiation element) second radiation element 66 including the signal feed connection 30 in communication with the first radiation element.

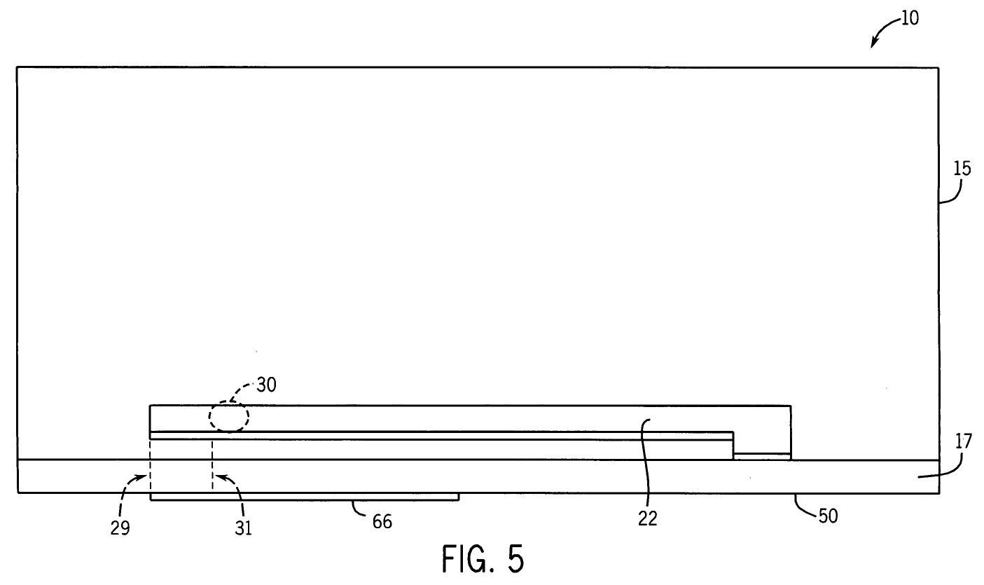

In one embodiment as shown in FIG. 5, the ground connection 29 and the signal feed connection 31 connects the first radiation element 22 on the first face 15 of the PCB 10 to the second radiation element 66 on the rear face 50 of the PCB 10.

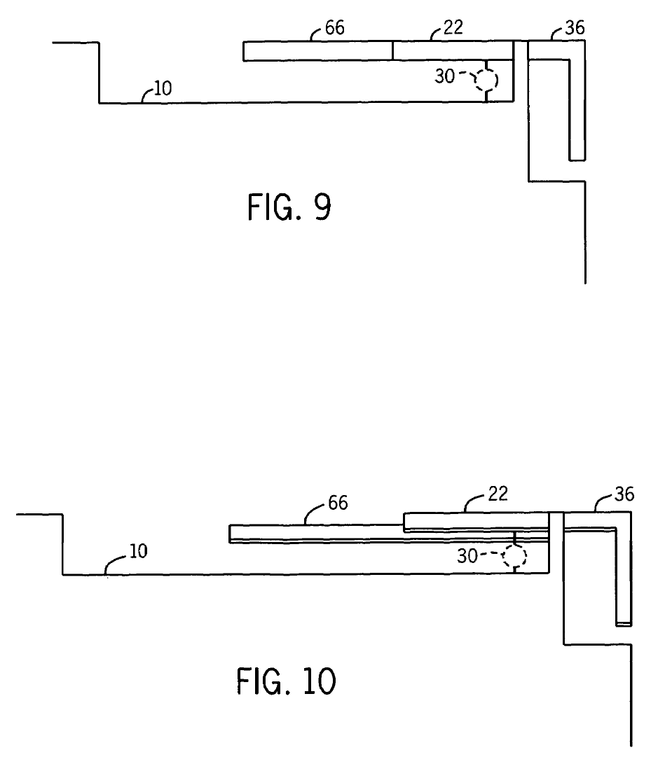

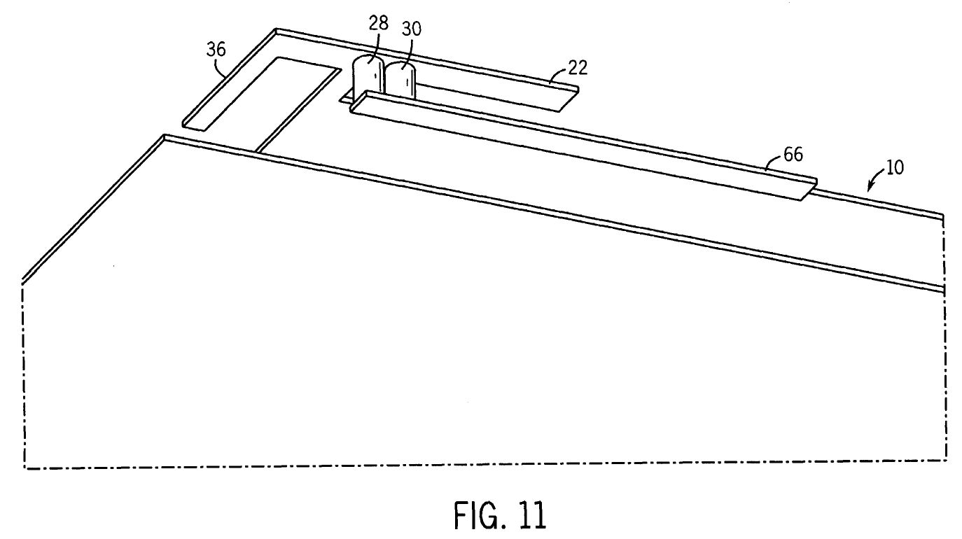

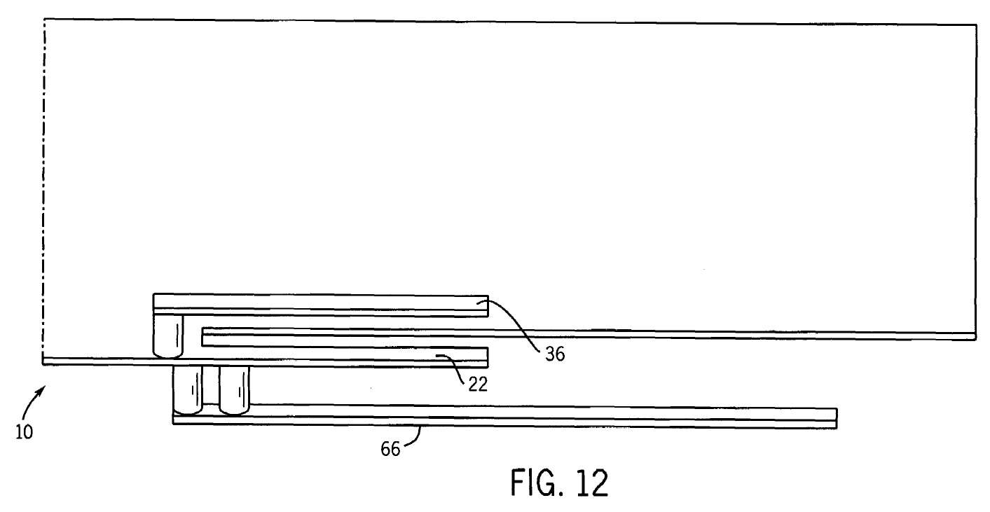

In one embodiment, the antenna includes more than two radiation elements. In one exemplary embodiment as shown in FIG. 9, the antenna includes a trace 36 which is not fed via the feed point 30, i.e. it is a parasitic trace. As shown in FIGS. 9-11, the parasitic trace 36 positioned on the first face 15 of the PCB 10 apart from the first trace 22 and is connected to the ground connection 29. In an alternative embodiment shown in FIG. 12, the parasitic trace 36 may be positioned above the first element 22, off the first face 15 and the second face 50.

In one exemplary embodiment, the first radiation element 22 and the second radiation element 66 are disposed on the PCB such that at least part of the elements 22, 66 would intersect with a plane orthogonal to the plane of the front and rear face. Preferably, the radiation elements 22, 66 would totally overlap as shown in FIG. 2, as this would provide a most space efficient solution.

In an exemplary embodiment, the ground points of the radiation elements 22, 66 are coupled to one another either directly as shown in FIG. 2, or via a ground plane (not shown) which may exist on an internal or external layer of the PCB 10. In one embodiment, the feed points 30, 64 are connected to one another and then fed to associated radio circuitry.

In an alternative arrangement, the feed points 30, 64 may not be connected to one another and may be connected to circuitry associated with each frequency of operation. In this embodiment, the circuitry associated with the first and second resonant frequency are operable simultaneously.

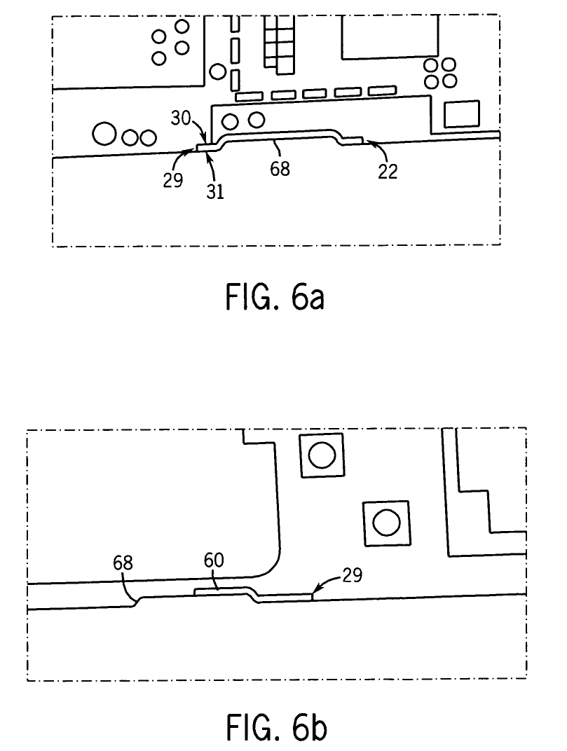

FIG. 2 illustrates the first antenna element 22 having a first associated length and the second antenna element 66 having a second associated length; the first and second length being different. The first and second length are dimensioned accordingly so that they resonate at the frequencies of interest. For example, the first radiation element 22 may be dimensioned to resonate at about 2.4 GHz, and the second radiation element 66 may be dimensioned smaller so as to resonate at about 5.8 GHz. FIGS. 6(a) (showing a first side of the PCB) and 6(b) (showing the second side of the PCB) illustrate an exemplary embodiment of the present invention wherein the PCB 10 includes a notched area 68 corresponding to the radiation elements 22, 66.

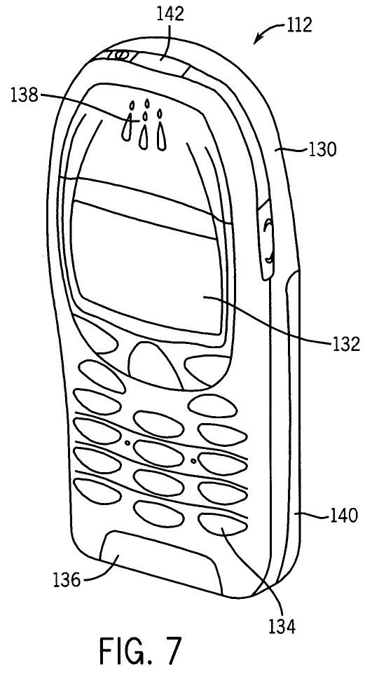

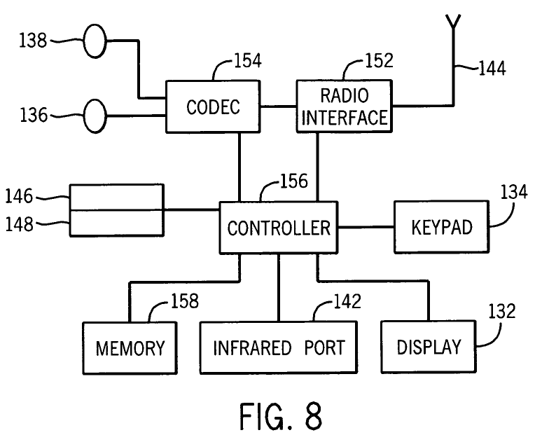

FIGS. 7 and 8 show one representative mobile telephone 112 within which the present invention may be implemented. It should be understood, however, that the present invention is not intended to be limited to one particular type of mobile telephone 112 or other electronic device. FIG. 7 depicts a mobile telephone having digital camera functionality in accordance with the principles of the present invention. The mobile telephone 112 of FIG. 7 includes a housing 130, a display 132 in the form of a liquid crystal display (LCD), a keypad 134, a microphone 136, an ear-piece 138, a battery 140, an infrared port 142, a smart card 146, in the form of a universal integrated circuit card (UICC) according to one embodiment of the invention, a card reader 148, radio interface circuitry 152, codec circuitry 154, a controller 156 and a memory 158. The mobile telephone 112 also includes a dual band antenna 144 in accordance with the principles of the present invention. Individual circuits and elements are all of a type well known in the art, for example in the Nokia range of mobile telephones. Other types of electronic devices within which the present invention may be incorporated can include, but are not limited to, personal digital assistants (PDAs), integrated messaging devices (IMDs), desktop computers, and notebook computers. FIG. 8 illustrates a schematic of the components of the mobile phone 112 of FIG. 7.

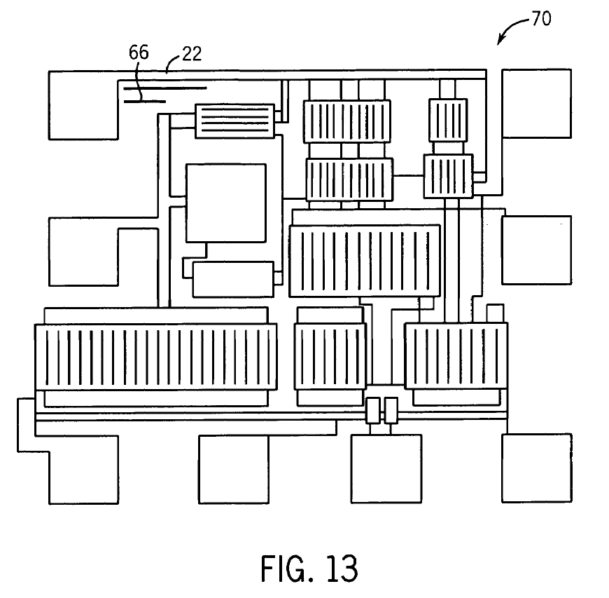

While the invention as been primary described in the context of a PCB, in an exemplary embodiment illustrated in FIG. 13, the antenna elements 22, 66 of the present invention are positioned on an integrated circuit 70. In one embodiment, the antenna elements 22, 66 are integrated into the body of the integrated circuit 70. The integrated circuit 70 itself may be mounted on a PCB 10.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments, and with various modifications, as are suited to the particular use contemplated.

What is claimed is:

1. A dual band antenna, comprising;
a circuit board having a plurality of layers;
a first antenna element formed on a first layer and having a ground connection;
a second antenna element formed on a second layer and having a ground connection; and
a common feed circuit connected to the first antenna element and second antenna element.

2. A dual band antenna according to claim 1, wherein the first and second antenna elements are positioned adjacent to an edge of the circuit board.

3. A dual band antenna according to claim 1, wherein the first and second layers are parallel to each other, and wherein the first and second antenna elements overlap in a plane orthogonal to the plane of the first and second layers.

4. A dual band antenna according to claim 3, wherein the circuit board has a front face and a rear face, and wherein the first layer is the front face and the second layer is the rear face.

5. A dual band antenna according to claim 4, wherein the first antenna element is resonant at a first frequency and the second antenna element is resonant at a second frequency and the first and second resonant frequencies are not adjacent.

6. A dual band antenna according to claim 3, wherein at least one of the first and the second layer is an internal layer of the circuit board

7. A dual band antenna according to claim 6, wherein the first antenna element is resonant at a first frequency and the second antenna element is resonant at a second frequency and the first and second resonant frequencies are not adjacent.

8. A dual band antenna according to claim 7, wherein the first and second resonant frequencies have a ratio of greater that 2:1.

9. A dual band antenna according to claim 8, wherein the first and second antennas elements have an electrical length equivalent to one quarter wavelength.

10. A dual band antenna according to claim 9, wherein the first and second antenna elements are inverted F antennas.

11. A dual band antenna according claim 1, wherein the first antenna and the second antenna elements are resonant at frequencies that correspond to frequencies allocated for Wireless Local Area Network operation.

12. A portable radio device, comprising;
a circuit board for mounting components and having a plurality of layers;
a first antenna element formed on a first layer of the circuit board and having a ground connection;
a second antenna element formed on a second layer of the circuit board and having a ground connection; and
a common feed circuit connected to the first antenna element and the second antenna element;
wherein the first and second antenna elements are positioned-adjacent to an edge of the circuit board.

13. A portable radio device according to claim 12, wherein at least one of the first layer and the second layer is an internal layer of the circuit board.

14. A portable radio device according to claim 12, wherein the first and second layers are parallel to each other, and wherein the first and second antenna elements overlap in a plane orthogonal to the plane of the first and second layers.

15. A portable radio device according to claim 14, wherein at least one of the first layer and the second layer is an internal layer of the circuit board.

16. A portable radio device according to claim 12, wherein the circuit board has a front and a rear face, and wherein the first layer is the front face of the circuit board and the second layer is the rear face of the circuit board.

17. A portable radio device according to claim 12, further comprising a third antenna element on the printed circuit board having a ground connection but no feed connection.

18. A method for dual band communication, comprising:
positioning a first antenna element on a first layer of a circuit board element substantially at an edge of the first layer of the circuit board, the first antenna element having a ground connection, a feed connection and a first length;
positioning a second antenna element on a second layer of a circuit board substantially at an edge of the second layer of the circuit board, the second antenna. positioned substantially parallel to the first antenna element and sharing the ground connection and the feed connection with the first antenna element, the second antenna element having a second length;
wherein the first length and the second length are different.

19. The method of claim 18, wherein the first and second antenna elements are resonant at frequencies that correspond to frequencies allocated for Wireless Local Area Network operation.

20. The method of claim 18, wherein the first antenna element is resonant at a first frequency and the second antenna element is resonant at a second frequency, and wherein the first and second resonant frequencies are not adjacent.

21. The method of claim 20, wherein the first and second resonant frequencies have a ratio of greater that 2:1.

22. The method of claim 18, wherein the first antenna element and the second antenna element are separated with at least one additional layer of the circuit board.

23. The method of claim 18, wherein the first antenna element and the second antenna element are inverted F antennas.

24. A communications device, comprising;
a circuit board for mounting components and having a plurality of layers;
a first antenna element formed on a first layer of the circuit board and having a ground connection,
a second antenna element formed on a second layer of the circuit board and having a ground connection, and
a common feed circuit connected to the first antenna element and the second antenna element,
wherein the first and second antenna elements are positioned adjacent to an edge of the circuit board.

25. A module for a communications device, comprising:
a first layer and a second layer;
a first antenna element formed on the first layer and having a ground connection,
a second antenna element formed on the second layer and having a ground connection, and
a common feed circuit connected to the first antenna element and the second antenna element.

26. The module of claim 25, wherein the module includes an integrated circuit and the first antenna element and the second antenna element are embedded in the integrated circuit.

27. The module of claim 25, wherein the module includes a printed circuit board and the first antenna element and the second antenna element are formed on the printed circuit board.
